(19) United States
(12) Patent Application Publication
(10) Pub. No.: US 2026/0309967 A1
(43) Pub. Date: Oct. 8, 2026

(54) AN IMAGING DEVICE AND A METHOD FOR IMAGING

(71) Applicant: IMEC VZW, Leuven (BE)

(72) Inventors: Zhenxiang LUO, Leuven (BE); Ziduo LIN, Haverlee (BE); Abdulkadir YURT, Korbeek-Lo (BE); Murali JAYAPALA, Kumtich (BE)

(21) Appl. No.: 19/478,925

(22) PCT Filed: Apr. 24, 2024
(86) PCT No.: PCT/EP2024/061198

§ 371 Date: Oct. 27, 2025

(30) Foreign Application Priority Data
Apr. 28, 2023 (EP) 23170607.8

(51) Int. Cl. G02B 21/00; G02B 21/10; G02B 21/26

(52) U.S. Cl. CPC G02B 21/0076; G02B 21/0032; G02B 21/008; G02B 21/10; G02B 21/26

(57) ABSTRACT

An imaging device (100; 200; 300; 400; 1000; 1100; 1200) comprises: at least one light-emitting element (104; 204; 304; 404; 604; 1004; 1104; 1204) outputting emitted light towards an object plane; a light modulator (110; 210; 310; 410; 710; 810; 910; 1010; 1110; 1210); and an image sensor (140; 240; 340; 440; 640; 1040; 1140; 1240), wherein the light-emitting element (104; 204; 304; 404; 604; 1004; 1104; 1204) is arranged between the light modulator (110; 210; 310; 410; 710; 810; 910; 1010; 1110; 1210) and the image sensor (140; 240; 340; 440; 640; 1040; 1140; 1240); wherein the light modulator (110; 210; 310; 410; 710; 810; 910; 1010; 1110; 1210) spatially modulates the emitted light for affecting an illumination pattern in the object plane, and spatially modulates light received back from the object plane forming modulated light propagating towards the image sensor (140; 240; 340; 440; 640; 1040; 1140; 1240).

### TECHNICAL FIELD

The present description relates to an imaging device and a method for imaging. In particular, the present description relates to imaging which need not involve a lens for forming an image of an object.

### BACKGROUND

Fluorescence imaging is used in various applications. For instance, fluorescence imaging is an important tool in biology and medicine studies thanks to fluorescence imaging providing high contrast, high resolution, and target-specific visual information of samples.

However, fluorescence imaging typically uses lens-based imaging systems, wherein lenses are used for imaging samples onto an image sensor. Lens-based imaging systems are bulky, expensive and have a field of view which is limited by the lenses. Thus, there is an interest in providing an improved imaging which is not limited by use of lenses and which would enable compact imaging with a large field of view.

### SUMMARY

An objective of the present description is to enable imaging using compact imaging equipment and to enable imaging of a large field of view.

This and other objectives are at least partly met by the invention as defined in the independent claims. Preferred embodiments are set out in the dependent claims.

According to a first aspect, there is provided an imaging device comprising: a light source comprising at least one light-emitting element configured to output emitted light towards an object plane to be imaged; a light modulator arranged to receive light from the at least one light-emitting element; and an image sensor comprising a plurality of light-sensitive elements, wherein each light-sensitive element is configured to generate a signal representative of intensity of light incident onto the light-sensitive element, wherein the at least one light-emitting element is arranged between the light modulator and the image sensor; wherein the light modulator is configured to spatially modulate the emitted light for affecting an illumination pattern in the object plane based on the emitted light, and wherein the light modulator is further configured to spatially modulate light received back from the object plane to form modulated light propagating towards the image sensor.

The imaging device uses a light modulator, which is configured to affect the illumination pattern for illuminating objects or samples to be imaged, and which is also configured to modulate light received back from objects or samples to be imaged towards the image sensor. This implies that the emitted light propagating from the light-emitting elements towards the object plane is propagating away from the image sensor. Hence, the imaging device may be set up such that the image sensor only receives light that has interacted with the object or sample to be imaged.

For instance, in fluorescence imaging, the emitted light may form excitation light for exciting fluorescence from an object or a sample. Using the imaging device, the excitation light will not reach the image sensor and will not form any background light in the image sensor. This implies that the image sensor may detect light of interest originating from the object or sample to be imaged at a high signal-to-noise ratio.

The light modulator is configured to modulate emitted light from the light source towards the object plane and also to modulate light from the object plane towards the image sensor. The light modulator may hence have a two-fold function and both functions may be used for improving image resolution. Further, the light modulator is arranged in relation to the light source such that the light modulator is between the light source and the object plane to be imaged.

In embodiments, the spatial modulation of the emitted light may affect the illumination pattern such that the object plane is selectively illuminated.

For instance, the illumination pattern may form structured illumination of the object plane. This may involve that the illumination pattern forms one or more spots of illumination light, such that parts of the object plane are selectively illuminated. The illumination pattern may thus contribute to image resolution by using high resolution selective illumination.

In general terms, the light source in combination with the light modulator may be configured to form an illumination pattern which includes high spatial frequency components, such as sharp patterns, spots, or speckles. This may facilitate imaging with high spatial resolution.

Thanks to selective illumination, a sample to be imaged need not necessarily be sparse. The selective illumination may allow selectively illuminating a small part (e.g., a spot) of the object plane such that the imaging device may enable imaging a feature of interest in the illuminated part, while any other features arranged close to the illuminated part will not be illuminated and hence not affect imaging.

Thanks to the selective illumination, an entire object plane may not be illuminated throughout an imaging session. In fluorescence imaging, this implies that the entire object plane need not be continuously illuminated throughout the imaging session. This implies that less photobleaching of fluorescent molecules may occur and that longer imaging sessions may be used.

However, it should be realized that the light source and the light modulator are not necessarily configured to form an illumination pattern providing selective illumination of parts of the object plane or high spatial frequency components. According to an alternative, the illumination pattern may provide a uniform or relatively uniform illumination of the object plane.

Further, the spatial modulation of light received back from the object plane affects light propagating towards the image sensor. In embodiments, the light propagating towards the image sensor may be affected such that a sharp detection of information from the object plane may be provided by the image sensor. This may also contribute to image resolution since fine details of the object or sample to be imaged may be acquired through sharp detection of information.

The imaging device need not comprise any lens for forming an image onto the image sensor. The image sensor may be configured to detect a light pattern formed in a plane defined by the plurality of light-sensitive elements. The light pattern may form a representation for imaging of an object or sample to be imaged. The light pattern may be further used for forming a reconstruction of the object or sample being imaged such that a visualization of the object or sample may be formed.

Thanks to the imaging device not necessarily having any lens, the imaging device may be very compact. In addition, the imaging device may facilitate imaging of a large field of view of the object plane.

As used herein, object plane means a plane that the image sensor is configured to image. The object plane may typically be perpendicular to an optical axis, which also is a normal to a plane in which the image sensor is arranged. A set-up of the imaging apparatus defines the object plane. The imaging apparatus is configured to provide illumination of the object plane and is further configured to affect the light propagating towards the image sensor such that a sharp detection of information from the object plane may be provided by the image sensor.

It should be realized that the imaging device may be used for many different imaging modalities. As mentioned above, the emitted light may be used as excitation light, which may induce fluorescence. However, it should be realized that the imaging device is not limited to fluorescence imaging.

Rather, the emitted light may interact with objects or samples to be imaged in any manner, such as being elastically or inelastically scattered. For instance, the imaging device may be configured for holographic imaging using detection of an interference pattern based on interference between light being diffracted by objects or samples and non-diffracted light. Alternatively, the imaging device may be configured for dark-field imaging or interferometric imaging.

The light source may be implemented in many different manners. The light source may comprise one or more sources at which light is generated so as to form an origin of light. The light source may further comprise components for guiding light from the origin to a location at which emitted light is to be output.

The light source comprises at least one light-emitting element which is configured to output light towards the object plane. The light-emitting element(s) may comprise source(s) for generating light, such that light may be generated in the light-emitting element(s). However, the light-emitting element(s) may alternatively form an output, such that light is generated in another location and guided to the light-emitting element(s) for being output by the light-emitting element(s). The source(s) for generating light may for instance be formed by a laser and/or a light-emitting diode (LED).

In an embodiment, the light source may comprise a waveguide for propagating light through total internal reflection through the waveguide. The light source may for instance be configured for providing output of emitted light for total internal reflection fluorescence microscopy (TIRFM).

The light modulator may be a spatial light modulator which is configured to form a spatially varying modulation of light. Thus, modulation of light may vary along a wavefront of light being incident onto the light modulator or along a cross-section of a beam of light. The light modulator may be configured to modulate at least one of phase, amplitude, or polarization of light.

In embodiments, the imaging device may enable generating different illumination patterns. Thus, the illumination pattern may be varied, and an object plane may be imaged under different illumination patterns. This may allow combining information from imaging the object plane under a plurality of different illumination patterns. The combining of information from different illumination patterns may be used for high resolution imaging.

In embodiments, the imaging device may be configured to be controlled in order to generate different illumination patterns. The control of the imaging device may comprise controlling the light source and/or controlling the light modulator in order to control the illumination pattern being formed. For instance, the light source may be controlled in order to selectively activate light-emitting elements so as to provide illumination pattern from different positions. Alternatively, or additionally, the light modulator may be tunable so as to controllably change modulation provided by the light modulator and, hence, control the illumination pattern being formed.

The image sensor may be any sensor being able to detect and form a representation of incident light. The light-sensitive elements of the image sensor may be arranged in a regularly ordered array. The light-sensitive elements may define a plane in which incident light is detected. The image sensor may for instance be formed by a complementary metal-oxide-semiconductor (CMOS) sensor or a charge-coupled device (CCD) sensor.

As used herein, the term “light” should be interpreted broadly, so as to include but not be restricted to visible light. Rather, the term light may imply other parts of the electro-magnetic spectrum, such as ultraviolet light or infrared light.

The imaging device is configured to output light towards an object plane to be imaged. This does not imply that the imaging device is limited to output of light with any particular shape or direction of a light beam. Rather, the imaging device is defined in relation to the object plane such that it is defined that the light-emitting elements and the image sensor are at a same side in relation to the object plane. Further, while the imaging device is configured to allow a control of the illumination pattern in the object plane, it should be realized that the imaging device is not limited to imaging of any particular object or that the imaging device necessarily images objects arranged in the object plane. Rather, the imaging device may be configured to image anything that is illuminated by the emitted light and from which the image sensor receives light. The imaging device may thus be configured to image any environment or scene which may comprise one or more objects which may be illuminated by the imaging device and may be imaged by the image sensor. Thus, the imaging device may be configured to image objects which may have any shape or form, and which need not be arranged at a particular distance in relation to the light-emitting elements and the image sensor. For instance, the imaging device may be used for imaging a three-dimensional object, which may be at least partly arranged outside an object plane.

However, it should be realized that the imaging device may be advantageously used for imaging objects or samples which are arranged in a controlled manner in relation to the light-emitting elements and the image sensor. The imaging device may be configured to output an illumination pattern having high spatial frequency components, such as sharp patterns, spots, or speckles, in the object plane. Thus, the imaging device may be configured to provide an illumination pattern that is focused on a particular object plane. This may be useful for high resolution imaging.

It should further be realized that the imaging device may be configured to provide the illumination pattern in the object plane being arranged within a housing of the imaging device, wherein the light source, light modulator and image sensor are mounted in the housing. The imaging device may alternatively be configured to provide the illumination pattern in the object plane being external to the housing. The imaging device may also be equipped with a receiver structure for receiving an object or sample to be imaged and for controlling an arrangement of the object or sample to be imaged in the object plane.

Although reference is made herein to objects or samples to be imaged, it should be realized that the imaging device is not limited in relation to what can be imaged by the imaging device. However, the imaging device may advantageously be used for imaging of biological samples, such as any liquid sample in which one or more particles are arranged, or for imaging of biological objects, which may not necessarily be immersed in a liquid.

Nevertheless, it should be realized that when referring to object or samples to be imaged, no limitation as to the imaging capability of the imaging device should be implied.

The proposed imaging device can find use in studying diverse range of biological applications. For example, the imaging device can be used to interrogate model organisms (e.g., Caenorhabditis elegans and zebrafish) optically for studying cell, tissue, organ development, genetics, neurobiology, aging and longevity, drug discovery and toxicology, behavioral studies and so forth. More specifically, the proposed imaging device can be used to perform observation of morphology of model organisms at different stages of development, enabling detailed images of the model organism's anatomy to be provided.

The imaging device can be also used as a labelled imaging tool to study specific structures, organelles, or proteins within the model organism using fluorescent markers. This enables visualization of processes such as gene expression, protein localization, and cell dynamics.

The imaging device can be also used for gene expression analysis. Fluorescent reporters driven by specific promoters can be used to study gene expression patterns. By visualizing where certain genes are active within the organism, researchers can gain insights into developmental processes and regulatory networks.

High-throughput imaging capability provided by the imaging device can enable researchers to screen large numbers of organisms for phenotypic changes resulting from gene knockdown or mutation. Likewise, the imaging device can be also used to study the behaviors under different conditions.

Automated tracking systems coupled with microscopy can analyse locomotion, feeding, and response to stimuli, providing insights into neural circuits and sensory perception.

As an alternative, the proposed imaging device can also be provided as a versatile tool for characterizing immune cells (e.g. CAR T cells) in vitro, providing valuable insights into their functionality, behavior, and interactions with target cells and the microenvironment. Combined with advanced imaging techniques and quantitative analysis methods, light microscopy contributes to the development and optimization of immune cell-based immunotherapies. More specifically, this imaging device can enable users to observe the morphology of immune cells. Changes in cell shape, size, and membrane integrity can provide insights into cell activation, proliferation, and cytotoxicity, which can allow monitoring of immune cell viability and proliferation over time. By labelling cells with vital dyes or fluorescent markers, researchers can track cell division, assess cell death, and measure growth kinetics.

Using fluorescently labelled immune cells, researchers can track cell movement in real-time and assess factors influencing cell trafficking, such as chemokine gradients and extracellular matrix components. This can be used to study cell interactions with the tumour microenvironment or immune cells.

Co-culture assays with fluorescently labelled cells or tissues enable visualization of immune cell dynamics, cell-cell contacts, and spatial organization within complex cellular environments. This can be employed to analyse gene expression in cells using fluorescent reporters or immunofluorescence staining. This allows researchers to assess the expression levels, signalling molecules, or cytokines involved in immune cell function.

Finally, the imaging device being equipped with high-throughput imaging capabilities enables screening of large libraries of immune cells or target cells. High-content imaging assays can assess multiple parameters simultaneously, providing quantitative data for characterizing cell behavior and identifying therapeutic candidates.

According to an embodiment, the light source comprises a plurality of light-emitting elements and each light-emitting element forms a point source and wherein the light modulator is configured to shape a point spread function of the point source onto the object plane.

Each light-emitting element may be used as an individual origin of light for forming an individual part, such as a spot, of the illumination pattern in the object plane. The light-emitting elements may be arranged such that light from different light-emitting elements does not overlap in the object plane.

The light modulator may thus be configured to separately control the light emitted from each light-emitting element. The light modulator may for instance be used for focusing light output from each of the light-emitting elements.

The imaging device may be configured to be controlled such that the light output by each of the light-emitting elements may be scanned in relation to the object plane. This may be achieved by controlling the light emitted by each of the light-emitting elements and/or controlling the light modulator for altering the illumination pattern in the object plane, such as moving the spots formed by light from the light-emitting elements. Alternatively, an object or sample to be imaged may be moved in the object plane.

It should be realized that the imaging device may alternatively be configured to form an illumination pattern in the object plane, wherein light from two or more different light-emitting elements interfere or overlap in the object plane for defining the illumination pattern. The imaging device may also in such case be configured to be controlled such that the illumination pattern may be changed. This may be achieved by controlling the light emitted by each of the light-emitting elements, including selectively activating or de-activating one or more light-emitting elements, and/or controlling the light modulator, for altering the illumination pattern in the object plane.

According to an embodiment, the light modulator is configured to shape a point spread function of light originating from one or more high spatial frequency components formed by the illumination pattern in the object plane.

The light modulator may thus be configured to control light propagating from the object plane towards the image sensor. The light modulator may for instance shape the point spread function such that light is focused onto the plurality of light-sensitive elements of the image sensor so that a sharp representation of the object or sample to be imaged may be formed.

The light modulator may be configured to shape the point spread function of light output by the imaging device as well as shape the point spread function of light received from the object or the sample to be imaged. This implies that a structured illumination may be provided in combination with a control of light received from the object or the sample to be imaged is provided, facilitating high resolution imaging. In addition, the same light modulator may be used both for providing structured illumination and for engineering a point spread function of received light, such that the imaging device may be compact.

The high spatial frequency components may correspond to any type of sharp patterns in the illumination pattern. The high spatial frequency components may for instance be formed by spots or speckles of the illumination pattern.

According to an embodiment, the light modulator is configured to provide a phase and/or amplitude mask of light passing through the light modulator for spatially shaping the light.

Thus, the light modulator may be configured to modulate phase and/or amplitude of light passing through the light modulator. In this respect, the light modulator may be viewed as forming a phase and/or amplitude mask.

An amplitude mask may be configured to modulate amplitude of light incident on the light modulator, e.g., by passing, blocking, or attenuating light propagating through the light modulator. The amplitude mask may be configured to reduce intensity of light and may thus be used in applications having relatively high intensity of light.

A phase mask may be configured to modulate phase of light incident on the light modulator. Thus, the phase mask may pass all or almost all light incident on the light modulator. This implies that a high signal-to-noise ratio may be provided.

Further, it should be realized that the light modulator may provide a combination of modulating phase and amplitude of incident light. In addition, it should be realized that the light modulator need not necessarily form a phase mask or an amplitude mask. Rather, the light modulator may modulate light based on a different characteristic of light, such as using polarization of light.

According to an embodiment, the at least one light-emitting element is arranged on a transparent substrate and wherein light received back from the object plane passes through the transparent substrate towards the image sensor.

This implies that the light-emitting elements may be arranged on a substrate which may facilitate providing a plurality of light-emitting elements in the imaging device. The substrate may carry the light-emitting element(s) and may define position(s) of the light-emitting element(s). Thanks to the substrate being transparent, the substrate may be arranged between the object plane and the image sensor without affecting imaging.

The substrate may also carry components for output of light by the light-emitting elements. Thus, the substrate may comprise electrical wires for providing electrical signals that may trigger output of light by the light-emitting elements and/or waveguides for guiding light to the light-emitting elements.

According to an embodiment, the at least one light-emitting element is formed by a light-emitting diode (LED).

The imaging device may comprise a plurality of light-emitting elements. In such case, each light-emitting element may be formed by an individual LED.

LEDs may be suitably used as LEDs may be simple and small light sources that may be arranged between the image sensor and the object plane without any significant effect on throughput of light from the object plane to the image sensor. For instance, the LEDs may be formed by micro-LEDs using microscopic scale LEDs.

It should be realized that the light source need not necessarily use LEDs for output of light. Rather, the light source may instead comprise one or more laser sources. However, if laser source(s) are used, it may be desired not to include the laser source(s) for generating laser light in a path between the object plane and the image sensor.

According to an embodiment, the light source comprises one or more waveguides for propagating light to the at least one light-emitting element and wherein the at least one light-emitting element is configured to couple out light from the one or more waveguides towards the object plane.

This may be suitably used in combination with a laser source although it should be realized that light generated by LED(s) may also be guided by waveguides to the light-emitting element(s). The use of waveguides may ensure that light propagating between the object plane and the image sensor is minimally affected by the light-emitting elements being possibly arranged therebetween. For instance, there may be no need for electrical wires connecting to the light-emitting elements.

The light-emitting element(s) may comprise a light re-directing element, which may be configured to re-direct light propagating in the waveguide so as to couple out light towards the object plane. Thus, the waveguide(s) may be arranged in a plane of the substrate such that the waveguide(s) propagate light along the plane. The light re-directing element(s) may thus be configured to re-direct light propagating along the plane of the substrate such that light is re-directed out of the substrate. For instance, the light re-directing element may comprise a mirror or a grating.

According to an alternative, each waveguide may be formed by an optical fiber. In such case, each light-emitting element(s) may be formed by a facet of an optical fiber.

According to an embodiment, the one or more waveguides are arranged below the image sensor and wherein the at least one light-emitting element configured to couple out light from the one or more waveguides is configured to output light from a location above the image sensor.

This implies that the at least one light-emitting element may be arranged on a substrate, which may be arranged below the image sensor, i.e., the image sensor being arranged between the substrate and the light modulator and object plane. Thus, the waveguide(s) may be arranged on a substrate which may facilitate mounting of the waveguide(s). The substrate does in such case not need to be transparent since light does not need to pass the substrate before reaching the image sensor.

The light-emitting elements may be configured to protrude from the substrate such that light is passed from the substrate through a plane defined by the image sensor to be output by the light-emitting elements at a position between the image sensor and the object plane. Light may be propagated by the light-emitting elements through the plane defined by the image sensor between light-sensitive elements of the image sensor.

According to an embodiment, the imaging device further comprises a translator for moving an object in a direction perpendicular to the object plane for enabling imaging of the object in three dimensions.

The light modulator may be configured to provide focused illumination and focused detection of light in the object plane, such that the imaging device may be configured to acquire two-dimensional image information from the object plane. Thanks to the use of the translator, three-dimensional imaging for moving the object (or sample) to be imaged may then be provided by sequentially providing a multitude of two-dimensional imaging.

According to an embodiment, the imaging device further comprises a filter arranged between the light modulator and the image sensor, wherein the filter is configured to filter light based on at least one of wavelength, polarization, or angle of incidence for suppressing undesired light from reaching the image sensor.

The filter may thus be used for avoiding undesired light from reaching the image sensor. This may be used for providing a high signal-to-noise ratio of light detection by the image sensor.

The filter may for instance be used for filtering light based on wavelength. This is useful when the imaging device is to be used for detecting fluorescence light, since the filter may be used for blocking any excitation light wavelength while passing fluorescence light. While the light source may be configured to output light away from the image sensor, the filter may still be useful in avoiding that any stray light from the light source does not reach the image sensor.

The filter may alternatively or additionally be used for filtering light based on polarization. The object or sample to be imaged may scatter light, which may change polarization of light or cause light to be polarized. Thanks to using a filter based on polarization of light, light which has not been scattered by the object or sample may be prevented from reaching the image sensor, so as to increase signal-to-noise ratio.

The filter may alternatively or additionally be used for filtering light based on angle of incidence. This may be used for instance for dark field imaging.

According to an embodiment, the at least one light-emitting element, the filter and the image sensor are integrated on a common substrate.

This implies that the imaging device may be very compact. The light-emitting element may comprise a transparent substrate, which is integrated on the common substate.

The imaging device may be configured such that the image sensor is arranged on the common substrate with the image sensor being arranged to face the light modulator and the object plane. The filter may be arranged on the image sensor between the image sensor and the light modulator. The at least one light-emitting element may be arranged on the filter between the filter and the light modulator.

It should be realized that the imaging device need not necessarily comprise a filter. Still, the at least one light-emitting element and the image sensor may be integrated on the common substrate. In such case, the light-emitting element may be arranged on the image sensor between the image sensor and the light modulator.

According to an embodiment, the filter is configured to suppress light having small angle of incidence and pass light having a large angle of incidence for dark-field imaging.

The filter may thus be configured to block light propagating at a small angle in relation to a normal of the filter. This may be useful for preventing any specular reflections from reaching the image sensor, such that background noise is substantially reduced. This may be used for dark-field imaging, in which light being scattered into large angles are detected.

According to an embodiment, the light source is configured to output light for exciting fluorescence and wherein the image sensor is configured to detect fluorescent light.

The imaging device may provide imaging of fluorescent light using a very compact set-up without need of any lenses for forming an image of the object or sample to be imaged.

According to an embodiment, the image sensor is configured to detect an interference pattern based on emitted light being scattered by an object and on emitted light being reflected or directly directed towards the image sensor.

The interference pattern may be used for holographic imaging such that the interference pattern detected by the image sensor may be used for reconstructing a visual representation of the object or sample being imaged. The interference pattern may be formed by scattered light and reference light which has not been scattered by the object or sample being imaged. The reference light may be formed by light which is output towards the object or sample to be imaged and which undergoes specular reflection, for instance by a (partially) reflective surface arranged behind the object or image to be sampled (as seen from the emitted light from the light-emitting elements) or by the light modulator forming a partially reflective surface.

The reference light may alternatively be formed by light which is allowed to pass directly from the light-emitting elements towards the image sensor. In such case, the light-emitting element need not provide any directional output of light. Rather, the light-emitting element may be configured to output light in all directions and, in particular, towards the image sensor which may be below the light-emitting element as well as towards the object plane which may be above the light-emitting element.

According to a second aspect, there is provided a method for imaging comprising: output emitted light towards an object plane by a light source comprising at least one light-emitting element; affect an illumination pattern of the emitted light in the object plane based on a light modulator spatially modulating the emitted light; modulate light received back by the light modulator from the object plane to form modulated light; and detecting the modulated light being incident on a plurality of light-sensitive elements of an image sensor.

Effects and features of this second aspect are largely analogous to those described above in connection with the first aspect. Embodiments mentioned in relation to the second aspect are largely compatible with the first aspect.

The method may allow imaging using high signal-to-noise ratio, since light from a light source is directed away from the image sensor. Thus, background noise of light from the light source that has not interacted with the object or sample to be imaged may be reduced.

Further, the use of the light modulator for modulating light towards the object plane and for modulating light from the object plane towards the image sensor may be utilized for high resolution imaging. The modulation of emitted light may provide an illumination pattern for structured illumination allowing high resolution features for illuminating the object or sample to be imaged.

Further, the modulation of light received back from the object plane may allow sharp detection of high spatial frequency information from the object plane such that fine details of the object or sample to be imaged may be detected.

### BRIEF DESCRIPTION OF THE DRAWINGS

The above, as well as additional objects, features, and advantages of the present description, will be better understood through the following illustrative and non-limiting detailed description, with reference to the appended drawings. In the drawings like reference numerals will be used for like elements unless stated otherwise.

FIG. 1 is a schematic view of an imaging device according to a first embodiment.

FIG. 2 is a schematic view of an imaging device according to a second embodiment.

FIG. 3 is a schematic view of an imaging device according to a third embodiment.

FIG. 4 is a schematic view of an imaging device according to a fourth embodiment.

FIG. 5 is a top view of arrangement of light-emitting elements in relation to image sensor of the imaging device of any embodiment.

FIGS. 6a-6b are a top view and a side view of another arrangement of a light source in relation to the image sensor.

FIG. 7 is a schematic view of a light modulator according to an embodiment.

FIGS. 8a-8c are schematic views of a light modulator according to another embodiment illustrating control of modulation by the light modulator.

FIGS. 9a-9b are schematic views of a light modulator according to yet another embodiment illustrating control of modulation by the light modulator.

FIG. 10 is a schematic view of an imaging device according to a fifth embodiment.

FIG. 11 is a schematic view of an imaging device according to a sixth embodiment.

FIG. 12 is a schematic view of an imaging device according to a seventh embodiment.

FIG. 13 is a flow chart of a method according to an embodiment.

### DETAILED DESCRIPTION

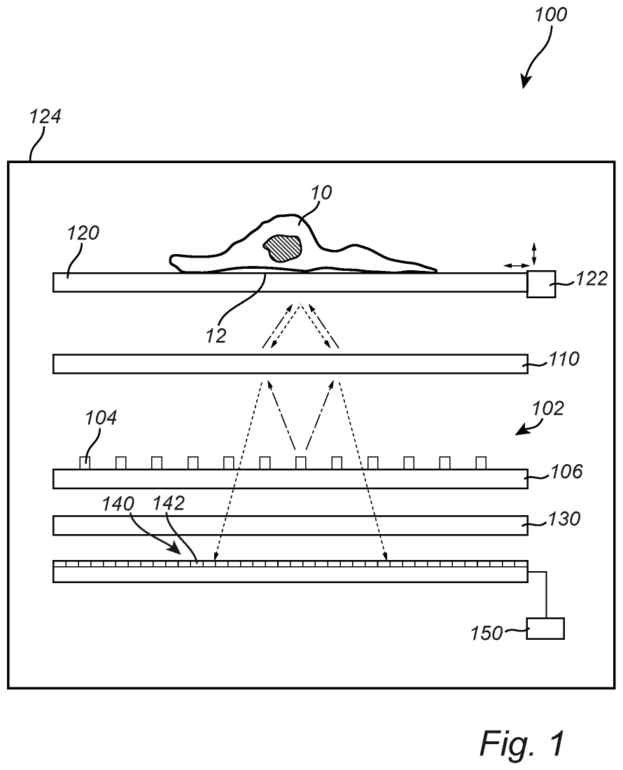

Referring now to FIG. 1, an imaging device 100 according to a first embodiment will be described. The imaging device 100 is described in relation to fluorescence imaging, wherein fluorescence is induced by emitting excitation light. Although reference is made to fluorescence imaging, it should be realized that the imaging device 100 is not limited to solely being used for fluorescence imaging and other types of imaging are possible, as will also be exemplified below.

The imaging device 100 comprises a light source 102. As shown in FIG. 1, the light source 102 may comprise a plurality of light-emitting diodes (LEDs) 104, such as micro-LEDs, wherein each LED 104 forms a separate light-emitting element. The LEDs 104 may be individually controlled, which may be used for individually activating or de-activating each LED 104.

The LEDs 104 may be arranged on a surface of a transparent substrate 106. The LEDs 104 may further be configured to output emitted light mainly in a forward direction away from the transparent substrate 106. Thus, the LEDs 104 may be configured such that light from the LEDs 104 may not propagate back through the transparent substrate 106.

The imaging device 100 further comprises a light modulator 110. The light modulator 110 may be arranged to receive light from the LEDs 104. Thus, the surface of the transparent substrate 106 on which the LEDs 104 are arranged may face the light modulator 110.

The light modulator 110 is configured to spatially modulate emitted light from the LEDs 104. The emitted light from the LEDs 104 may propagate through the light modulator 110 while being modulated by the light modulator 110. The light modulator 110 may thus affect the emitted light from the LEDs 104.

The imaging device 100 may be configured to image an object 10 or sample that is arranged in an object plane 12. The LEDs 104 and the light modulator 110 may be configured to form an illumination pattern in the object plane illuminating the object or sample arranged therein. The modulation of the emitted light by the light modulator 110 may thus affect the illumination pattern. For instance, the light modulator 110 may be configured to shape the illumination pattern forming a selective illumination of parts of the object plane. In this manner, structured illumination may be achieved such that an imaging resolution may be provided through the illumination pattern. The light modulator 110 may be configured to enhance a frequency band of an illumination point spread function (PSF) of the point source provided by each of the LEDs 104. The illumination pattern in the object plane may thus comprise high frequency components, such as spots or speckles.

Each LED 104 may be configured to emit light such that light from different LEDs 104 does not overlap when reaching the light modulator 110.

The light modulator 110 may further shape the illumination pattern such that light originating from different LEDs 104 does not overlap in the object plane. However, it should be realized that the illumination pattern in the object plane may be formed in different manners such that the illumination pattern is formed by interference or superposition of light from different LEDs 104.

The imaging device 100 may comprise a receiver structure 120 configured to receive an object 10 or sample to be imaged. The receiver structure 120 may be configured to control that the object 10 or sample to be imaged is properly placed in the object plane. Thus, the receiver structure 120 may for instance define a recess in which the object 10 or sample to be imaged may be placed, such as a recess formed to receive a slide holding the object 10 or sample to be imaged. Hereinafter, reference will be made to an object 10 being imaged although it should be realized that the imaging device 100 is not limited to what can be imaged in the imaging device 100.

The imaging device 100 may thus be configured to illuminate the object 10. The emitted light from the LEDs 104 may have a wavelength suitable for exciting the object 10 and causing fluorescence from the object 10. It should also be realized that the LEDs 104 may be configured to tune a wavelength for exciting different types of fluorescence. Alternatively, the plurality of LEDs 104 may include different types of LEDs 104 for outputting different wavelengths, such that the LEDs 104 may simultaneously or sequentially cause fluorescence based on different excitation wavelengths.

The light modulator 110 is further configured to receive light from the object 10 being illuminated by the illumination pattern. Thus, the fluorescence light from the object 10 may propagate through the light modulator 110 and may be spatially modulated by the light modulator 110. Thus, the light modulator 110 may be configured to shape light from the object 10, such as shaping the PSF from the object 10. In particular, the light modulator 110 may be configured to shape the PSF of selective points in the object plane, selected through the structured illumination.

The shaping of the PSF of light originating from the object plane may enhance detection of high frequency components of light from the object 10 so as to improve resolution of imaging of the object 10. Hence, the light modulator 110 may improve imaging resolution both based on the illumination of the object 10 and detection of the light received back from the object 10.

The fluorescence light from the object 10 may propagate through the light modulator 110 and may further propagate through the transparent substrate 106 on which the LEDs 104 are arranged. The imaging device 100 may further comprise a filter 130. The filter 130 may be arranged below the transparent substrate 106 such that the fluorescence light having passed the transparent substrate 106 is incident on the filter 130.

The filter 130 may be configured to block or suppress undesired light and prevent such undesired light from affecting detection of the fluorescence light. For instance, the filter 130 may be configured to filter light based on wavelength such that excitation light emitted by the LEDs 104 is blocked, while the fluorescence light is allowed to pass the filter 130. Thus, even though the LEDs 104 may be configured to output light such that the emitted light should not propagate back through the transparent substrate 106, the filter 130 may be used for preventing any stray light, e.g., from specular reflections, from passing the filter 130.

The imaging device 100 further comprises an image sensor 140. The image sensor 140 may be configured to receive fluorescence light that has passed the filter 130. The image sensor 140 may comprise a plurality of light-sensitive elements 142 arranged in a plane, defining an image plane of the imaging device 100. The light modulator 110 may be configured to spatially modulate light from the object 10 so as to shape a light pattern in the image plane, e.g., by shaping the PSF originating from the object 10 onto the image plane.

The image sensor 140 may be any sensor being able to detect and form a representation of incident light. The light-sensitive elements 142 of the image sensor may be arranged in a regularly ordered array. The image sensor 140 may for instance be formed by a complementary metal-oxide-semiconductor (CMOS) sensor or a charge-coupled device (CCD) sensor.

Each light-sensitive element 142 is configured to generate a signal representative of intensity of light incident onto the light-sensitive element 142.

The image sensor 140 may thus be configured to image the object 10 by forming a representation of fluorescence light from the object 10. The representation of the fluorescence light may be in the form of a pattern of light formed by the fluorescence light. The imaging device 100 need not include any imaging lens, such that the image sensor 140 may not immediately form a visually understandable image of the object 10.

The imaging device 100 may be configured to scan the illumination pattern in relation to the object 10 in order to image the entire object plane.

The imaging device 100 may comprise a translator for mechanically moving the object 10 in the object plane for scanning the object 10 in the object plane. Alternatively, or additionally, the imaging device 100 may be controlled such that the illumination pattern may be altered for scanning the illumination pattern in the object plane. The scanning of the illumination pattern may be achieved by changing characteristics of the emitted light from the LEDs 104, by changing which LED(s) 104 are active, and/or by tuning the modulation by the light modulator 110.

The imaging device 100 may further comprise a translator 122 for moving the object 10 in a direction perpendicular to the object plane. This implies that the object 10 may be moved such that different sections of the object 10 are sequentially arranged in the object plane. This may be used for enabling imaging of the object 10 in three dimensions.

The translator 122 for moving the object 10 in the direction perpendicular to the object plane may also be used for moving the object 10 in the object plane for scanning the object 10 in the object plane, as discussed above.

The imaging device 100 may further comprise a processing unit 150. The processing unit 150 may be configured to receive the representation of intensity of light incident on the array of light-sensitive elements 142 as detected by the image sensor 140. The processing unit 150 may be configured to process the representation received from the image sensor 140 so as to reconstruct a visual image of the object 10.

The processing unit 150 may be implemented as a general-purpose processing unit and the imaging device 100 may further comprise a computer program product comprising computer-readable instructions such that when executed on the processing unit 150 the computer program product will cause the processing unit 150 to form a reconstruction of the visual image of the object 10. However, the processing unit 150 may alternatively be implemented as firmware arranged, e.g., in an embedded system, or as a specifically designed processing unit, such as an Application-Specific Integrated Circuit (ASIC) or a Field-Programmable Gate Array (FPGA).

The processing unit 150 may be configured to reconstruct the visual image of the object 10 by taking into account the illumination pattern (structured illumination) and the shaping of the light pattern from the object 10 (engineered PSF).

The processing unit 150 may be part of the imaging device 100 and may be arranged in a physical housing 124 together with other parts of the imaging device 100. However, it should be realized that the imaging device 100 may alternatively be configured to acquire a representation of fluorescence light by the image sensor 140 and may further be configured to transmit such representation to a processing unit being external to the imaging device 100.

It should also be realized that a visual image need not necessarily be formed at all. The imaging device 100 may be used for analysis of an object 10, wherein forming of a visual image of the object 10 may not be strictly necessary. Rather, the representation of fluorescence light acquired by the image sensor 140 may be directly processed in order to analyze the object 10.

As illustrated in FIG. 1, the imaging device 100 may be configured such that components of the imaging device 100 are arranged in parallel planes, stacked on top of each other. Each component may be formed by a thin structure arranged in a separate plane.

As seen from the object plane, the image sensor 140 may be formed at a bottom (farthest away from the object plane), defining a plane in which the light-sensitive elements 142 are formed. The filter 130, if present, is arranged above the image sensor 140. The filter 130 may formed in a thin, flat structure configured to block or suppress undesired light.

The transparent substrate 106 carrying the light-emitting elements (LEDs 104) is arranged above the filter 130 and above the image sensor 140. The transparent substrate 106 and the LEDs 104 may form a thin, flat light emission unit providing multiple independent point light sources.

The light modulator 110 is arranged above the light-emitting elements (LEDs 104). Thus, the light-emitting elements 104 may be arranged between the image sensor 140 and the light modulator 110. The light modulator 110 may also be formed by a thin, flat structure.

The image sensor 140, the filter 130, the light-emitting elements 104 and the light modulator 110 may be provided in a compact arrangement, such that the imaging device 100 may be very small and compact. The image sensor 140, the filter 130, the light-emitting elements 104 and the light modulator 110 may be mounted in a fixed relation to each other in a housing 124. The receiver structure 120 may also be arranged within the housing 124 to provide a well-defined position of the object 10 to be imaged in relation to the image sensor 140, the light-emitting elements 104 and the light modulator 110.

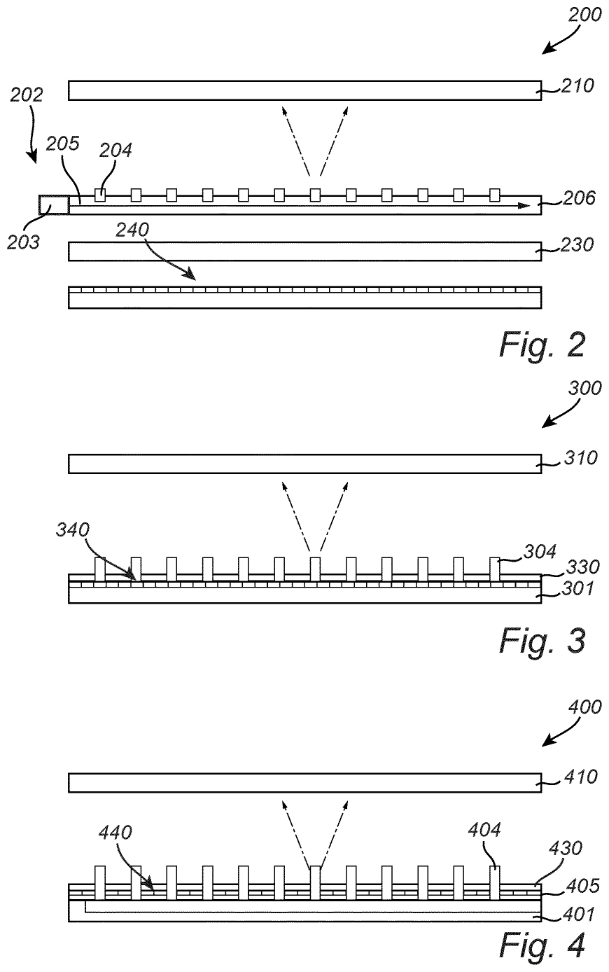

Referring now to FIG. 2, a second embodiment of the imaging device 200 is shown, illustrating an alternative embodiment of the light source 202. Only differences between the imaging device 200 according to the second embodiment and the imaging device 100 according to the first embodiment will be discussed. As shown in FIG. 2, the light source 202 may comprise a light generating source 203 for generating light. The light generating source 203 may for instance be a laser source but may alternatively be a LED.

The light source 202 may further comprise one or more waveguides 205 for propagating light from the light generating source 203. The waveguides 205 may be arranged on a transparent substrate 206 which may be arranged above the filter 230 and the image sensor 240 and between the image sensor 240 and the light modulator 210. Thus, the waveguides 205 may be configured to propagate light in the plane defined by the transparent substrate 206.

The light source 202 may further comprise a plurality of light-emitting elements 204. The light-emitting elements 204 may be configured to output light from the one or more waveguides 205, such as being formed by mirrors or gratings for coupling light propagating in the plane of the transparent substrate 206 out of the plane towards the light modulator 210. Thus, the light source 202 may output emitted light at the light-emitting elements 204 such that light for illuminating the object 10 is directed towards the object 10 from a plurality of positions originating from the plurality of light-emitting elements 204.

Hence, the light generating source 203 need not necessarily be arranged between the light modulator 210 and the image sensor 240. Rather, the light generating source 203 may be freely placed in the imaging device 200 and light may be guided form the light generating source 203 to the light-emitting elements 204. As illustrated in FIG. 2, the light generating source 203 may be arranged at an edge of the transparent substrate 206 for injecting light into transparent substrate from the edge. The transparent substrate 206 may form a waveguide plate.

Referring now to FIG. 3, a third embodiment of the imaging device 300 is shown, illustrating an alternative arrangement of components of the imaging device 300. Only differences between the imaging device 300 according to the third embodiment and the imaging devices 100, 200 according to the first and second embodiments will be discussed.

As shown in FIG. 3, components of the imaging device 300 may be integrated on a common substrate 301. In this manner, the imaging device 300 may be very compact. Also, the arrangement of components integrated on the common substrate 301 implies that each component need not be separately mounted in the housing of the imaging device 300, which may simplify assembly of the imaging device 300.

The image sensor 340 may be formed on the common substrate 301. The filter 330 may then be integrated immediately above the image sensor 340 or possibly with a spacer layer in-between. Further, the light-emitting elements in form of LEDs 304 may be mounted directly on the filter 330 or possibly on a layer that is integrated on the filter 330.

The light modulator 310 may be arranged separately and not arranged on the common substrate 301. This may ensure that the light modulator 310 is arranged at an appropriate distance from the LEDs 304 and the image sensor 340 for achieving appropriate shaping of light based on the modulation provided by the light modulator 310. However, it should be realized that the imaging device 300 may comprise a spacer layer between the LEDs 304 and the light modulator 310 such that the light modulator 310 may also be integrated on the common substrate 301.

It should be realized that instead of using LEDs 304, the light source may comprise a light generating source and one or more waveguides configured to propagate light to light-emitting elements arranged integrated above the filter 330.

Referring now to FIG. 4, a fourth embodiment of the imaging device 400 is shown, illustrating yet another alternative arrangement of components of the imaging device 300. Only differences between the imaging device 400 according to the fourth embodiment and the imaging devices 100, 200, 300 according to the first, second, and third embodiments will be discussed.

As shown in FIG. 4, similar to the imaging device 300 of the third embodiment, components of the imaging device 400 may be integrated on a common substrate 401. In this manner, the imaging device 300 may be very compact.

As shown in FIG. 4, the imaging device 400 may comprise one or more waveguides 405 formed in or on the common substrate 401. The image sensor 440 may be formed in a layer above the waveguides 405. The filter 430 may then be integrated immediately above the image sensor 440 or possibly with a spacer layer in-between.

Further, light-emitting elements 404 may be arranged to extend from a layer in which the waveguides 405 are formed, protrude through layers defined by the image sensor 440 and the filter 430 to extend to a location above the image sensor 440. In this manner, although waveguides 405 are arranged below the image sensor 440, light may be coupled out from the waveguides 405 to be output by light-emitting elements 404 arranged above the image sensor 440.

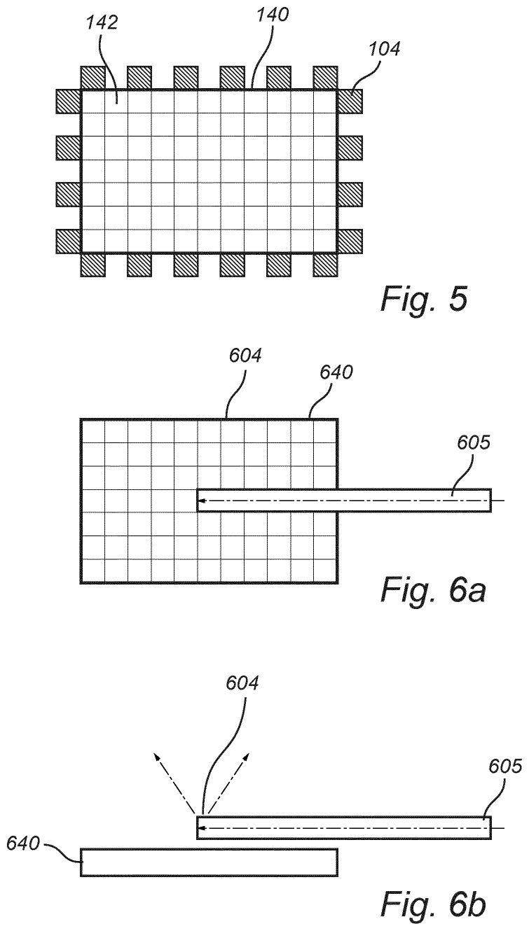

Referring now to FIG. 5, arrangement of the light-emitting elements 104 in relation to the image sensor 140 will be further discussed. Although shown for the first embodiment of the imaging device 100, it should be realized that this arrangement may equally apply to any of the other imaging devices 200, 300, 400 according to the second, third, and fourth embodiments discussed above.

In FIGS. 1-4, the light-emitting elements are indicated as being directly above the image sensor. In such arrangement, the light-emitting elements may partly affect imaging as some light may be blocked by the light-emitting elements so as not to reach the image sensor. However, as illustrated in the top view of the imaging device 100 in FIG. 5, the light-emitting elements 104 (LEDs) may be arranged around an area corresponding to the image sensor 140.

The LEDs 104 may be arranged in a plane above the image sensor 140. For instance, the LEDs 104 may be mounted on a transparent substrate 106 which may cover the area of the image sensor 140. However, the LEDs 104 may be mounted in positions corresponding to a periphery of the image sensor 140 such that the LEDs 104 do not block light directed towards the image sensor 140. Thus, a projection of a LED 104 along a normal of the plane in which the LEDs 104 are arranged onto the plane of the image sensor 140 will not fall within the area of the light-sensitive elements 142 or may fall at a peripheral area of the light-sensitive elements 142. Since the LEDs 104 may be arranged in a plane above the image sensor 140, the LEDs 104 may still be considered to be arranged between the light modulator 110 and the image sensor 140.

Referring now to FIGS. 6a-6b, yet another arrangement of a light-emitting element 604 will be described. FIG. 6a is a top view showing the light-emitting element 604 above the image sensor 640 and FIG. 6b is a cross-sectional view illustrating output of light from the light-emitting element 604.

As illustrated in FIG. 6a, light from a light generating source may be delivered through a waveguide 605 (e.g., an optical fiber) which may be arranged above the image sensor 640 so as to provide a very small impact on a field of view of the image sensor 640.

As illustrated in FIG. 6b, the light-emitting element 604 may be formed by an output facet of the waveguide 605. For instance, the waveguide 605 may be an optical fiber with an angle polished end facet in order to couple light out of the fiber and re-direct light propagating in a plane parallel to the image sensor 640 so as to output light away from the image sensor 640 towards the object to be imaged.

Now, the light modulator according to a few different embodiments will be further described in detail. The light modulator of any of these embodiments may be used with any of the embodiments of the imaging device 100, 200, 300, 400 described above.

The light modulator may be configured to apply a spatial modulation of light. The spatial modulation may occur based on interaction between the light modulator and light, which may involve absorption, refraction and/or scattering of light. The interaction between the light modulator and light may be dependent on a characteristic of light, such as wavelength or polarization of light.

The light modulator may be configured to provide a phase and/or amplitude mask of light passing through the light modulator for spatially shaping the light.

The imaging device may be configured to provide a static modulation of light by the light modulator. However, the imaging device may advantageously be used for altering an impact of the modulation. This may be used for altering the illumination pattern so as to control illumination of the object plane and ensure that the entire object plane may be imaged through sequential imaging of different parts of the object plane using structured illumination. Also, an impact of the modulation may be altered in order to provide a diversity of imaging which may be utilized in improving reconstruction of a visual image of the object to be imaged.

According to an embodiment, the light modulator may be static, whereas the light source may be changed so as to change the impact of the light modulator.

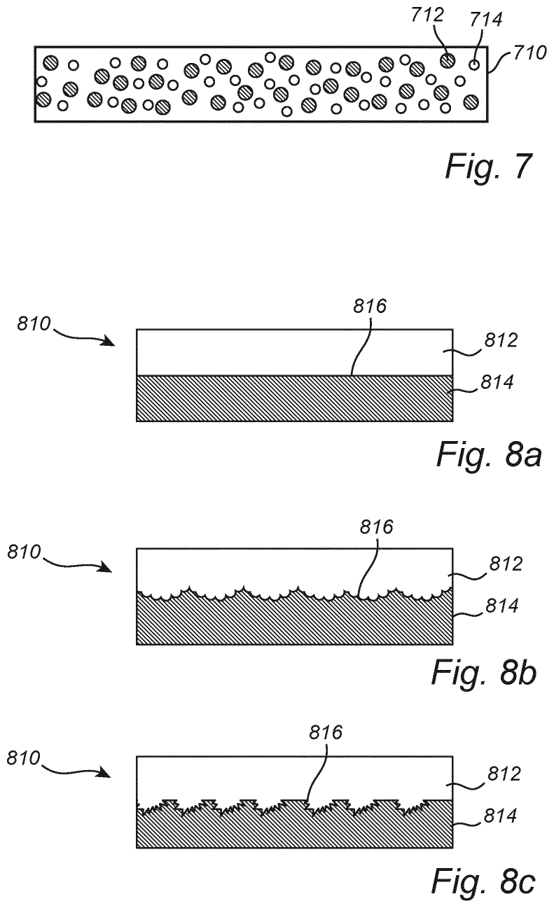

Referring now to FIG. 7, the light modulator 710 according to an embodiment is shown. The light modulator 710 may comprise scatterers 712, 714 of at least two different types. A first type of scatterer 712 may be configured to be transparent to a first wavelength while being configured to significantly absorb a second wavelength. A second type of scatterer 714 may be configured to significantly absorb the first wavelength while being configured to be transparent to the second wavelength. Thus, by tuning the light source between outputting the first wavelength and outputting the second wavelength, the response of the light modulator 710 may be altered in relation to the distribution of the first type of scatterers 712 and the second type of scatterers 714 in the light modulator 710.

Hence, the impact of the light modulator 710 for affecting the illumination pattern in the object plane, and the impact of the light modulator 710 for shaping light from the object towards the image sensor may be controlled by controlling the wavelength of the light source.

It should be realized that interaction with light by the scatterers 712, 714 of the at least two different types may depend on polarization instead of wavelength. Thus, first scatterers 712 and second scatterers 714 may align at different directions within the light modulator 710 in order to provide different responses based on light being polarized at different angles. Thus, by tuning the light source between outputting light with a first polarization angle and outputting light with a second polarization angle, the response of the light modulator 710 may be altered in relation to the distribution of the first type of scatterers 712 and the second type of scatterers 714 in the light modulator 710.

Referring now to FIGS. 8a-8c, a light modulator 810 according to another embodiment will be described. The light modulator 810 comprises at least a first material 812 and a second material 814. The first material 812 and the second material 814 may be arranged forming an interface 816 between the materials in the light modulator 810. The first and the second material may have different optical properties, such as different refractive indices.

A control signal may be applied to the light modulator 810. The control signal may then be configured to alter a shape of the interface 816, e.g., at a micrometer scale of the interface 816. Thus, when the control signal is applied, the interface 816 will change so as to alter the effect of the light modulator 810 on light changing the impact of modulation.

FIGS. 8a-c illustrate schematically how the interface 816 may be changed in dependence of a control signal, wherein FIG. 8a illustrates the interface 816 when no control signal is applied, FIG. 8b illustrates the interface 816 when a first control signal is applied and FIG. 8c illustrates the interface 816 when a second control signal is applied.

The control signal may for instance be an electrical signal, an acoustic signal, such as an acoustic standing wave, or a thermal signal. The control signal may for instance be applied at a surface of the light modulator 810.

The impact of the light modulator may alternatively be tuned by tuning the optical property of one or more materials of the light modulator instead of tuning an interface between two materials. Thus, the light modulator may comprise at least two materials with different optical properties, wherein the two materials are arranged within the light modulator in different layers or intermixed with each other.

The optical properties of the materials may be changed in dependence of a control signal so as to alter the impact of the light modulator. An effect of the control signal on the optical property may be different for different materials, such that the impact of the light modulator on light is dependent on the control signal. Again, the control signal may for instance be an electrical signal, an acoustic signal, such as an acoustic standing wave, or a thermal signal. When the control signal is applied, an optical property, such as a refractive index, change in a different manner for the first material and the second material of the light modulator so as to change the modulation provided by the light modulator.

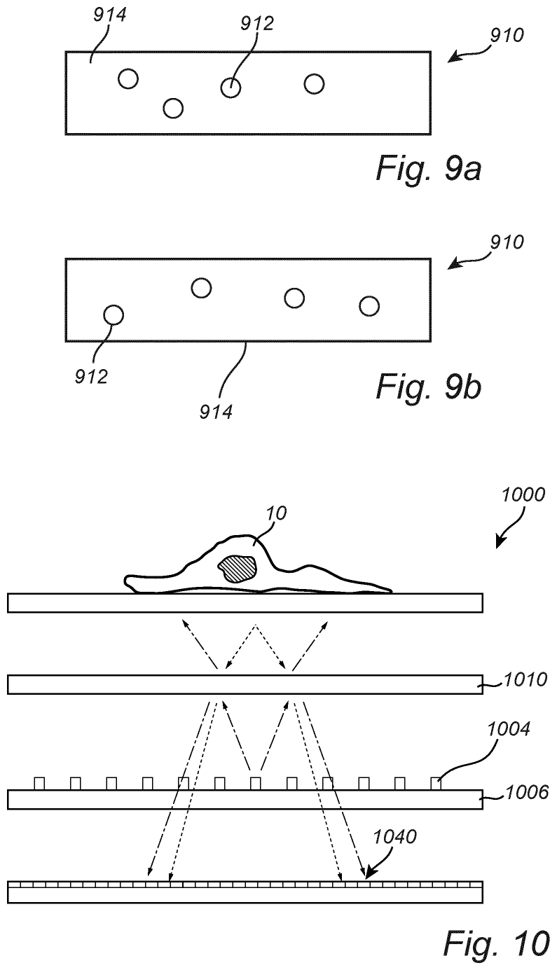

Referring now to FIGS. 9a-9b, a light modulator 910 according to yet another embodiment will be described. The light modulator 910 comprises particles 912 (or alternatively droplets) arranged within a medium 914, such as a liquid. The particles 912 and the medium 914 have different optical properties, such as different refractive indices.

A control signal may be applied to the light modulator 910. The control signal may then be configured to alter a distribution of the particles 912 in the medium 914. Thus, when the control signal is applied, the distribution of particles 912 will change so as to alter the effect of the light modulator 910 on light changing the impact of modulation.

FIGS. 9a-b illustrate schematically how the distribution of particles 912 may be changed in dependence of the control signal, wherein FIG. 9a illustrates a first distribution when a first control signal (or no control signal) is applied, and FIG. 9b illustrates a second distribution when a second control signal is applied.

The control signal may for instance be an electrical signal, an electro-magnetic signal, such as an electro-magnetic wave, an acoustic signal, such as an acoustic standing wave, or a magnetic field signal. The control signal may for instance be applied at a surface of the light modulator 910.

The light modulator 710, 810, 910 of any of the embodiments described above may enable a very high resolution of spatial modulation.

Spatial modulation may be provided by features of the light modulator 710, 810, 910 that are very small, wherein the features may be provided by individual scatterers/particles in the light modulator or by a spatial variation of a property of the light modulator (such as a variation in the interface between two materials). The features may thus enable a varying light modulating property of the light modulator to be provided. The light modulator 710, 810, 910 may be configured such that each feature affecting light propagation in the light modulator 710, 810, 910 need not be individually addressed, while allowing high resolution features to be involved in the modulation provided by the light modulator 710, 810, 910. Thus, the control signal or the tuning of the emitted light from the light-emitting elements may be configured to control the light modulating property of a plurality of features of the light modulator 710, 810, 910. This enables control of the light modulator 710, 810, 910 using a high resolution.

According to an embodiment, the features defining a spatial variation of the light modulation may have a size smaller than 10 um. This enables providing a high spatial resolution of the light modulation. According to another embodiment, the features defining a spatial variation of the light modulation may have a size smaller than a wavelength of the light being modulated by the light modulator 710, 810, 910. This may provide an extremely high spatial resolution of controlling the light modulator 710, 810, 910.

The light modulator 710, 810, 910 may comprise a large plurality of features that may not be individually controlled for controlling the modulation of light by the light modulator 710, 810, 910. The light modulator 710, 810, 910 should however provide a repeatable transfer function such that the modulation provided by the light modulator 710, 810, 910 by the control signal or by the tuning of the emitted light may be predicted.

Referring now to FIG. 10, an imaging device 1000 according to a fifth embodiment is described, wherein the imaging device 1000 is used for holographic imaging.

The imaging device 1000 is configured to image the object 10 using reflective holographic imaging, in that light is back-scattered by the object 10 in a reflective manner. The imaging device 1000 is configured such that an interference pattern may be formed between light being scattered by the object 10 and non-scattered light. The non-scattered light may be formed by a specular reflection of light. For instance, the specular reflection may be provided by a surface of the light modulator 1010. However, it should be realized that the specular reflection may take place at another surface, such as by a reflective surface being arranged behind the object 10, which may be used if a mainly transparent object is to be imaged.

The light modulator 1010 may be used for controlling the illumination pattern for illuminating the object 10, which may be used for forming structured illumination in the object plane. The light modulator 1010 may also be configured to shape the scattered light from the object 10 so as to enhance detection of high spatial frequency components, which are useful for providing high resolution holographic imaging.

The interference pattern formed between scattered light and non-scattered light represents information about the object 10. The image sensor 1040 may be configured to detect the interference pattern and the interference pattern may then be used for reconstructing a visual image representation of the object 10.

The imaging device 1000 may comprise a light source that includes a plurality of LEDs 1004 arranged on a transparent substrate 1006. However, it should be realized that the light source may be implemented in any of the manners described above.

The imaging device 1000 does not need to include any filter. There is no need to suppress or block excitation light, as described in the embodiments for fluorescence imaging.

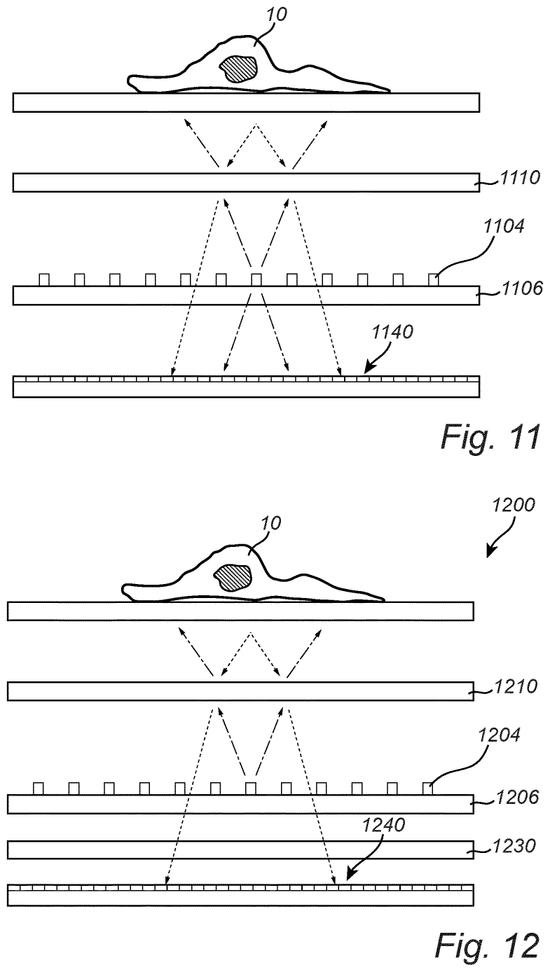

Referring now to FIG. 11, an imaging device 1100 according to a sixth embodiment is described. Like the imaging device 1000 of the fifth embodiment, the imaging device 1100 is used for holographic imaging.

The imaging device 1100 is configured to image the object 10 using reflective holographic imaging, in that light is back-scattered by the object 10 in a reflective manner. The imaging device 1100 is configured such that an interference pattern may be formed between light being scattered by the object 10 and non-scattered light. In the imaging device 1100 of the sixth embodiment, the non-scattered light is provided by light-emitting elements emitting light directly towards the image sensor 1140. Thus, the light-emitting elements 1104 may be configured to output light in opposite directions, towards the light modulator 1110 and the object plane for illuminating the object 10 and towards the image sensor 1140.

The interference pattern formed between scattered light and non-scattered light represents information about the object 10. The image sensor 1140 may be configured to detect the interference pattern and the interference pattern may then be used for reconstructing a visual image representation of the object 10.

The light modulator 1110 may be used for controlling the illumination pattern for illuminating the object 10, which may be used for forming structured illumination in the object plane. The light modulator 1110 may also be configured to shape the scattered light from the object 10 so as to enhance detection of high spatial frequency components, which are useful for providing high resolution holographic imaging.

The imaging device 1100 may comprise a light source that includes a plurality of LEDs 1104 arranged on a transparent substrate 1106. However, it should be realized that the light source may be implemented in any of the manners described above.

Referring now to FIG. 12, an imaging device 1200 according to a seventh embodiment is described, wherein the imaging device 1200 is used for dark-field imaging.

The imaging device 1200 is configured to image the object 10 using light that is back-scattered by the object 10 in a reflective manner. The imaging device 1200 is provided with an angular rejection filter 1230 which is configured to pass light therethrough in dependence of an angle of incidence of light on the angular rejection filter 1230. The dark-field imaging may be based on detection of light that is scattered into a large angle in relation to a normal of the object plane. Such scattered light will also have a large angle of incidence in relation to a normal of the angular rejection filter 1230. The angular rejection filter 1230 may be configured to block or suppress light having a small angle of incidence while the angular rejection filter 1230 is configured to pass light having a large angle of incidence. In this manner, specular reflections and other background noise may be removed such that the image sensor 1240 may detect a low level of background noise allowing dark-field imaging.

The light modulator 1210 may be used for controlling the illumination pattern for illuminating the object 10, which may be used for forming structured illumination in the object plane. The light modulator 1210 may also be configured to shape the scattered light from the object 10 so as to enhance detection of high spatial frequency components, which are useful for providing high resolution imaging.

The imaging device 1200 may comprise a light source that includes a plurality of LEDs 1204 arranged on a transparent substrate 1206. However, it should be realized that the light source may be implemented in any of the manners described above.

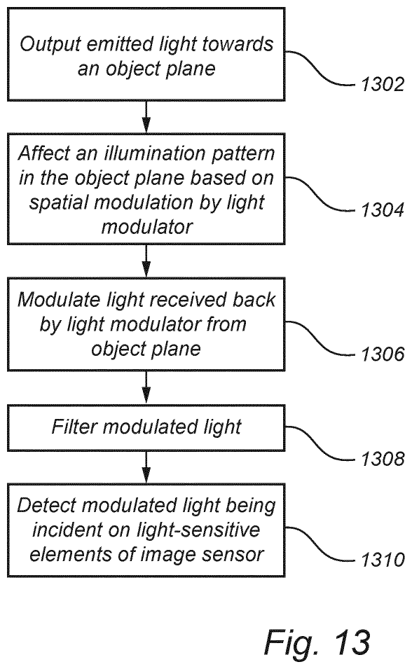

Referring now to FIG. 13, a method for imaging will be briefly summarized. The method may be used by any of the embodiments of the imaging device described above.

The method comprises outputting 1302 emitted light towards an object plane by a light source comprising at least one light-emitting element. As mentioned above, the light-emitting element may be formed by a LED such that light is generated by the light-emitting element or the light-emitting element may be configured to output light that is guided in a waveguide to the light-emitting element from a light generating source.

The method further comprises affecting 1304 an illumination pattern of the emitted light in the object plane based on a light modulator spatially modulating the emitted light. Thus, the light modulator may be configured to spatially modulate the emitted light output by the light-emitting element(s).

The light modulator may shape the light to control the illumination pattern formed in the object plane. The illumination pattern may for instance be used for structured illumination in the object plane.

The method further comprises modulating 1306 light received back by the light modulator from the object plane to form modulated light. Light output for illumination of the object plane shares a common path with light from the object plane that is to be detected by the image sensor. The light received back is modulated by the same light modulator that modulates the light output by the light-emitting element(s) towards the object plane. The modulation of light received back from the object plane allows the light from the object plane to be shaped, which may be used for enhancing detection of high frequency components of light from the object so as to improve resolution of imaging of the object.

The method may possibly comprise filtering 1308 the modulated light to suppress or block undesired light from reaching an image sensor. The filtering may for instance use a wavelength filter so as to remove light of an excitation wavelength and pass light of an emission wavelength in fluorescence imaging.

The method further comprises detecting 1310 the modulated light being incident on a plurality of light-sensitive elements of an image sensor.

Thus, the image sensor may detect a representation of the object, by detecting a pattern of light formed by the light from the object plane.

The method may further comprise reconstructing a visual image representation of an object in the object plane based on the detected representation by the image sensor.

In the above the inventive concept has mainly been described with reference to a limited number of examples. However, as is readily appreciated by a person skilled in the art, other examples than the ones disclosed above are equally possible within the scope of the inventive concept, as defined by the appended claims.

1. An imaging device comprising:
a light source comprising at least one light-emitting element configured to output emitted light towards an object plane to be imaged;
a light modulator arranged to receive light from the at least one light-emitting element; and
an image sensor comprising a plurality of light-sensitive elements, wherein each light-sensitive element is configured to generate a signal representative of intensity of light incident onto the light-sensitive element, wherein the at least one light-emitting element is arranged between the light modulator and the image sensor.
wherein the light modulator is configured to spatially modulate the emitted light for affecting an illumination pattern in the object plane based on the emitted light, and wherein the light modulator is further configured to spatially modulate light received back from the object plane to form modulated light propagating towards the image sensor.

2. The imaging device according to claim 1, wherein the light source comprises a plurality of light-emitting elements and each light-emitting element forms a point source and wherein the light modulator is configured to shape a point spread function of the point source onto the object plane.

3. The imaging device according to claim 1, wherein the light modulator is configured to shape a point spread function of light originating from one or more high spatial frequency components formed by the illumination pattern in the object plane.

4. The imaging device according to claim 1, wherein the light modulator is configured to provide a phase and/or amplitude mask of light passing through the light modulator for spatially shaping the light.

5. The imaging device according to claim 1, wherein the at least one light-emitting element is arranged on a transparent substrate and wherein light received back from the object plane passes through the transparent substrate towards the image sensor.

6. The imaging device according to claim 1, wherein the at least one light-emitting element is formed by a light-emitting diode (LED).

7. The imaging device according to claim 1, wherein the light source comprises one or more waveguides for propagating light to the at least one light-emitting element and wherein the at least one light-emitting element is configured to couple out light from the one or more waveguides towards the object plane.

8. The imaging device according to claim 7, wherein the one or more waveguides are arranged below the image sensor and wherein the at least one light-emitting element configured to couple out light from the one or more waveguides is configured to output light from a location above the image sensor.

9. The imaging device according to claim 1, further comprising a translator for moving an object in a direction perpendicular to the object plane for enabling imaging of the object in three dimensions.

10. The imaging device according to claim 1, further comprising a filter arranged between the light modulator and the image sensor, wherein the filter is configured to filter light based on at least one of wavelength, polarization or angle of incidence for suppressing undesired light from reaching the image sensor.

11. The imaging device according to claim 10, wherein the at least one light-emitting element, the filter and the image sensor are integrated on a common substrate.

12. The imaging device according to claim 10, wherein the filter is configured to suppress light having small angle of incidence and pass light having a large angle of incidence for dark-field imaging.

13. The imaging device according to claim 1-11, wherein the light source is configured to output light for exciting fluorescence and wherein the image sensor is configured to detect fluorescent light.

14. The imaging device according to claim 1, wherein the image sensor is configured to detect an interference pattern based on emitted light being scattered by an object and on emitted light being reflected or directly directed towards the image sensor.

15. A method for imaging comprising:
output emitted light towards an object plane by a light source comprising at least one light-emitting element;
affect an illumination pattern of the emitted light in the object plane based on a light modulator spatially modulating the emitted light;
modulate light received back by the light modulator from the object plane to form modulated light; and
detecting the modulated light being incident on a plurality of light-sensitive elements of an image sensor.
